(19) United States
(12) Patent Application Publication
(10) Pub. No.: US 2017/0001419 A1
(43) Pub. Date: Jan. 5, 2017

(54) MULTI-STAGE COMPOSITES

(71) Applicant: PRESIDENT AND FELLOWS OF HARVARD COLLEGE, Cambridge, MA (US)

(72) Inventors: Ju-Hee SO, Cambridge, MA (US); Alok Suryavamsee TAYI, Somerville, MA (US); Rui M.D. NUNES, Somerville, MA (US); George M. WHITESIDES, Newton, MA (US)

(21) Appl. No.: 15/114,148

(22) PCT Filed: Jan. 28, 2015
(86) PCT No.: PCT/US15/13291

§ 371 Date: Aug. 15, 2016

Related U.S. Application Data
(60) Provisional application No. 61/933,510, filed on Jan. 30, 2014.

(51) Int. Cl. B32B 27/08; B32B 7/04; B32B 5/02; B32B 27/32; B32B 25/12; B32B 25/08; B32B 3/28; B32B 37/18; B32B 37/00; B32B 37/14; B32B 38/00; B32B 7/14; B32B 27/40

(52) U.S. Cl. CPC B32B 27/08; B32B 7/14; B32B 7/045; B32B 5/02; B32B 27/32; B32B 25/12; B32B 27/40; B32B 3/28; B32B 37/182; B32B 37/0084; B32B 37/144; B32B 38/0012; B32B 25/08; B32B 2250/24; B32B 2262/0269; B32B 2274/00; B32B 2307/202; B32B 2307/51; B32B 2307/54; B32B 2457/00; B32B 2038/0028; B32B 2323/04; B32B 2317/22; B32B 2377/00; B32B 2375/00; B29K 2623/06; B29K 2607/00

(57) ABSTRACT

Multi-stage composite materials, their preparation, and their uses are described. A composite includes a first layer of a first material contributing to mechanical strength of the composite having a first length, and a second layer of a second material contributing to the mechanical strength of the composite having a second length, wherein the second length is greater than the first length, wherein the second length of the second layer is affixed to the first length of the first layer at both ends of the first and second lengths so that the second layer is spaced apart from the first layer.

### RELATED APPLICATION

This patent application claims the benefit of the earlier filing date of U.S. Patent Application No. 61/933,510, filed on Jan. 30, 2014, the contents of which are incorporated by reference herein in its entirety.

### STATEMENT OF GOVERNMENT RIGHTS

This invention was made with government support under Grant No. W911NF-09-1-0476 awarded by the US Army Research Office and Grant No. N00014-10-1-0942 awarded by Office of Naval Research. The government has certain rights in this invention.

### TECHNICAL FIELD

The field of this application generally relates to multi-stage composites, their preparation, and their uses.

### BACKGROUND

Most materials have static mechanical properties that do not adapt in response to stimuli (e.g., stress, strain, environmental conditions, and patterns of use, etc.). For example, the elastic deformation of a conventional structural material or composite usually shows an approximately constant Young's modulus: the stress increases linearly as a function of strain, until the material fails by plastic deformation or fracture. These circumstance-invariant mechanical properties can make engineering design simpler, but constrain the use of these materials. For example, on one hand, metals are stiff materials with high Young's modulus, but can fail by fatigue at low strain; and on the other hand, elastomers have low Young's modulus and stretch easily under stress, but can deform severely at high stress.

### SUMMARY

Multi-stage composites, e.g., materials that exhibit different mechanical responses under different stimuli, their preparation, and their uses are described.

Disclosed subject matter includes, in one aspect, a composite, which includes a first layer of a first material contributing to mechanical strength of the composite having a first length, and a second layer of a second material contributing to the mechanical strength of the composite having a second length, wherein the second length is greater than the first length, wherein the second length of the second layer is affixed to the first length of the first layer at both ends of the first and second lengths so that the second layer is spaced apart from the first layer.

In an aspect, a composite, which includes a first layer of a first material having a first length requiring a first load to produce each unit of incremental extension; and a second layer of a second material having a second length requiring a second load to produce each unit of incremental extension, wherein the second length is greater than the first length, wherein the second length of the second layer is affixed to the first length of the first layer at both ends of the first and second lengths so that the second layer is spaced apart from the first layer; and wherein, extension of the composite from the first length to the second length results in at least one change in the load required to produce each unit of incremental extension.

In some embodiments, the Young's modulus of the second material is same as the Young's modulus of the first material. In some other embodiments, the second load required to produce each unit of incremental extension of the second material is same as the first load required to produce each unit of incremental extension of the first material

In some embodiments, the Young's modulus of the second material is different from the Young's modulus of the first material. In some other embodiments, the second load required to produce each unit of incremental extension of the second material is different from the first load required to produce each unit of incremental extension of the first material

In some embodiments, the Young's modulus of the second material is greater than the Young's modulus of the first material. In some embodiments, the second load required to produce each unit of incremental extension of the second material is greater than the first load required to produce each unit of incremental extension of the first material.

In some embodiments, the Young's modulus of the second material is at least an order of magnitude greater than the Young's modulus of the first material. In some embodiments, the second load required to produce each unit of incremental extension of the second material is at least an order of magnitude greater than the first load required to produce each unit of incremental extension of the first material.

In some embodiments, the second layer is affixed to the first layer at at least one additional contact region so that the second layer includes at least two spaced apart sections.

In some embodiments, the at least two spaced apart sections have the same arc length.

In some embodiments, the at least two spaced apart sections have different arc lengths.

In some embodiments, the composite further includes a third layer of a third material contributing to the mechanical strength of the composite having a third length, wherein third length is greater than the second length, wherein the third length of the third layer is affixed to the first and second lengths at both ends of the first, second, and third lengths so that the third layer is spaced apart from the first and second layers.

In some embodiments, the composite further comprising, a third layer of a third material having a third length requiring a third load to produce each unit of incremental extension, wherein third length is greater than the second length, wherein the third length of the third layer is affixed to the first and second lengths at both ends of the first, second, and third lengths so that the third layer is spaced apart from the first and second layers; and wherein, extension of the composite from the first length to the third length results in at least two changes in the load required to produce each unit of incremental extension.

In some embodiments, the Young's modulus of the third material is same as the Young's modulus of the second material. In some other embodiments, the third load required to produce each unit of incremental extension of the third material is same as the second load required to produce each unit incremental extension of the second material.

In some embodiments, the Young's modulus of the third material is different from the Young's modulus of the second material. In some other embodiments, the third load required to produce each unit incremental of extension of the third material is different from the second load required to produce each unit of incremental extension of the second material.

In some embodiments, the Young's modulus of the third material is greater than the Young's modulus of the second material. In some other embodiments, the third load required to produce each unit incremental extension of the third material is greater than the second load required to produce each unit of incremental extension of the second material.

In some embodiments, the Young's modulus of the third material is at least an order of magnitude greater than the Young's modulus of the second material. In some other embodiments, the third load required to produce each unit of incremental extension of the third material is at least an order of magnitude greater than the second load required to produce each unit of incremental extension of the second material.

In some embodiments, the third layer is affixed to the second layer at at least one additional contact region so that the number of spaced apart sections in the third layer is greater than the number of spaced apart sections in the second layer.

Disclosed subject matter includes, in another aspect, a method of preparing a composite, which includes providing a first layer of a first material contributing to mechanical strength of the composite having a first length, providing a second layer of a second material contributing to the mechanical strength of the composite having a second length, wherein the second length is greater than the first length, and affixing the second length of the second layer to the first length of the first layer at both ends of the first and second lengths so that the second layer is spaced apart from the first layer.

In another aspect, a method of preparing a composite, which includes providing a first layer of a first material having a first length requiring a first load to produce each unit of incremental extension; providing a second layer of a second material having a second length, requiring a second load to produce each unit of incremental extension wherein the second length is greater than the first length; and affixing the second length of the second layer to the first length of the first layer at both ends of the first and second lengths so that the second layer is spaced apart from the first layer; and wherein, extension of the composite from the first length to the second length results in at least one change in the load required to produce each unit of incremental extension of the composite.

In some embodiments, the method further includes providing a third layer of a third material contributing to the mechanical strength of the composite having a third length, wherein third length is greater than the second length, and affixing the third length of the third layer to the first and second lengths at both ends of the first, second, and third lengths so that the third layer is spaced apart from the first and second layers. In some embodiments, the method further includes providing a third layer of a third material having a third length requiring a third load to produce each unit of incremental extension, wherein third length is greater than the second length; and affixing the third length of the third layer to the first and second lengths at both ends of the first, second, and third lengths so that the third layer is spaced apart from the first and second layers; and wherein, extension of the composite from the first length to the second length results in at least one change in the load required to produce each unit of incremental extension of the composite.

Disclosed subject matter includes, in yet another aspect, a device, which includes a first layer of a first material contributing to mechanical strength of the device having a first length, and a second layer of a second material contributing to the mechanical strength of the device having a second length, wherein the second length is greater than the first length, wherein the second length of the second layer is affixed to the first length of the first layer at both ends of the first and second lengths, wherein the second layer is spaced apart from the first layer in an unengaged state, wherein the second layer is no longer spaced apart from the first layer in an engaged state.

In yet another aspect, a device, which includes a first layer of a first material having a first length requiring a first load to produce each unit of incremental extension; and a second layer of a second material having a second length requiring a second load to produce each unit of incremental extension, wherein the second length is greater than the first length, wherein the second length of the second layer is affixed to the first length of the first layer at both ends of the first and second lengths, wherein the second layer is spaced apart from the first layer in an unengaged state, wherein the second layer is no longer spaced apart from the first layer in an engaged state.

In some embodiments, the first load required to produce each unit of incremental extension of the first layer and the second load required to produce each unit of incremental extension of the second layer have the same value

In some embodiments, the first layer contains a first active section, the second layer contains a second active section, the first and second active sections are not in contact in the unengaged state, and the first and second active sections are in contact in the engaged state.

In some embodiments, the first active section contains a first conductive strip, and the second active section contains a second conductive strip.

Disclosed subject matter includes, in another aspect, a method of using the composite including applying a first strain to the composite to stretch the first layer from its original first length to the second length of the second layer, wherein the first strain requires the application of a first load to produce each unit of incremental extension ; and applying a second strain to the to the composite to stretch the first and second layer from the second length to a length greater than the second length, wherein the second strain requires the application of a second load to produce each unit of incremental extension.

### BRIEF DESCRIPTION OF THE DRAWINGS

The following figures are provided for the purpose of illustration only and are not intended to be limiting.

FIG. 1 illustrates mechanism properties of some exemplary materials, Latex rubber, Polyethylene (PE), and Kevlar aramid, that can be used to form multi-stage composites;

FIG. 2(A) illustrates an exemplary two-stage composite where one strip is longer than the other strip by ΔL;

FIG. 2(B) illustrates the two-step modulus of the Latex-PE composite, in which the different in length between the two strips (ΔL) is about 10 mm;

FIG. 2(C) illustrates that different ΔLs can lead to different threshold extensions;

FIG. 2(D) illustrates reversibility of mechanical properties of the multi-stage composite illustrated in FIG. 2(A);

FIG. 3(A), illustrates that when the longer layer is affixed to the shorter layer at two more contact points/lines/regions, the amplitude of the curve (A) can be reduced to about A/3 while the wavelength (L) decreases to about L/3;

FIG. 3(B) illustrates that a two-stage composite maintains its two-step modulus with little change when the number of waves in the longer layer of the composite is one, two, three, or four;

FIG. 4(A) illustrates a two-stage Latex-PE composite with three segments;

FIG. 4(B) illustrates the mechanical properties of the Latex-PE composite illustrated in FIG. 4(A);

FIG. 5 illustrates another exemplary two-stage composite with diagonal attachment lines;

FIG. 6(A), three layers can be used to form a three-stage composite;

FIG. 6(B) illustrates reversibility of mechanical properties of the multi-stage composite illustrated in FIG. 6(A);

FIG. 7(A) illustrates a Latex-PE-Kevlar three-layer composite;

FIG. 7(B) illustrates the mechanical properties of the Latex-PE-Kevlar composite illustrated in FIG. 7(A);

FIG. 8(A), illustrates the effect of compression on a ballon. The top left diagram shows an inflated rubber balloon. The top right diagram shows the inflated rubber balloon compressed along its vertical direction. The bottom left diagram shows an inflated rubber balloon that is wrapped around by a PE-Latex two-stage composite strip. The bottom right diagram shows the inflated rubber balloon with the composite strip is compressed along its vertical direction;

FIG. 8(B), illustrates the measured load of the balloon with the composite strip shows a higher load than a plain balloon in greater than 60 mm of compression strain;

FIG. 9(A) illustrates a single electric switch can be manufactured using a PE-Latex composite;

FIG. 9(B) illustrates that multi-stage composites (e.g. Latex-PE composites) can be used to manufacture multi-switch electrical circuits;

FIG. 10 illustrates another exemplary application of an exemplary multi-stage composite.; and

FIG. 11(A) demonstrates an example of two-dimensional stepped modulus composite fabricated using a PE-latex composite with an octagonal web-like configuration showing a PE-latex layered composite with an octagonal, web-like configuration at rest on the left and in tension on the right.

FIG. 11(B) shows the force-extension profiles of a single PE (Δ), a single latex (□) and the PE-latex composite () of the web configuration shown in FIG. 11A.

### DETAILED DESCRIPTION

The patent and scientific literature referred to herein establishes knowledge that is available to those of skill in the art. The issued U.S. patents, allowed applications, published foreign applications, and references, that are cited herein are hereby incorporated by reference to the same extent as if each was specifically and individually indicated to be incorporated by reference.

For convenience, certain terms employed in the specification, examples and claims are collected here. Unless defined otherwise, all technical and scientific terms used in this disclosure have the same meanings as commonly understood by one of ordinary skill in the art to which this disclosure belongs. The initial definition provided for a group or term provided in this disclosure applies to that group or term throughout the present disclosure individually or as part of another group, unless otherwise indicated.

Circumstance-adaptive materials (CAM) can change their properties (e.g., mechanical, optical, electrical, magnetic, and biological properties, etc.) in response to use or environment (e.g., temperature, water content, electric or magnetic fields, patterns and history of use, etc.). Such materials are of interest in many technical applications, but pose a challenge in materials science and engineering. As an example of CAM in the nature, sea cucumbers can rapidly change their stiffness by secreting chemicals into their dermis that control the interactions among the collagen fibers that determine their mechanical properties.

Mechanical stress can serve as a stimulus to change mechanical properties of materials. For example, collagenous biomaterials, such as mammalian skin, arteries, ligaments, and tendons, can change their mechanical properties in response to mechanical stimuli. These biomaterials exhibit increasing modulus with applied strain, a phenomenon also referred to as strain stiffening, and the change can be reversible. This nonlinear behavior may be attributed to the crimped geometrical arrangement of the collagen fibers in elastin matrix. The stiffness of the materials increases as failure approaches. This feature can limit mechanical failure (e.g., a tear of the skin) at large extensions. Mathematical analysis has showed that strain stiffening can be beneficial for improving fault tolerance of structural materials. However, although strain stiffening has been observed among natural biomaterials, it has been difficult to achieve among synthetic materials and systems.

Embodiments of the subject matter disclosed herein can include composites that demonstrate different mechanical properties at different stages of extension, referred to herein as “multi-stage composites.” Examples of multi-staged composites include multi-layered composites that can respond to mechanical stimuli by changing their Young's modulus with changes in external strain. In one illustrative example, a multi-stage composite can include two layers of materials having different mechanical properties and physical dimensions: a shorter and elastic layer (e.g., Latex rubber) and a longer and stiff material (e.g., polyethylene (PE), Kevlar, etc.). The two layers can be affixed to one another at the opposing edges of each layer. Because of the length difference between the two layers, the longer layer spans the shorter layer and the excess length can form a spaced-apart structure over the shorter layer when the ends of the two layers are aligned and affixed together. When tensional strain is applied on the layered composite in its longitudinal direction, e.g., the composite is extended or stretched, the composite can exhibit a two distinct Young's moduli in two discrete steps. At low strains, the shorter and elastic layer dominates the mechanical properties of the composite. When strain on the composite is such that its length equals the length of the longer and stiff layer, the mechanical properties of the stiff material begin to dominate the mechanical properties of the composite. Thus, the composite can demonstrate strain stiffening behavior.

The multi-stage composites can have more than two stages of moduli. In some embodiments, the composite can possess as many steps in modulus as the number of constituent material layers. Embodiments of the disclosed subject matter can have tunable strain stiffening properties. Stepped moduli of the composites can be configured by changing the composition and the configuration of individual materials to achieve different numbers of steps in modulus, the ranges of steps, and the mechanical strength at each step. In some embodiments, when a composite has more than two steps in modulus, the materials of the composite can be layered in a hierarchical structure, resulting a smaller footprint of the composite while maintaining its performance and mechanical properties.

In some embodiments, a multi-stage composite can also possess tunable mechanical strength in response to compression as well as tension, when the compression on a coupled system is transduced to tension on the multi-stage composite. Multi-stage composites disclosed herein can be used in a wide range of situations (e.g., as sensor, actuator, etc.) In one example, an electric sensor using a multi-stage composite can monitor the amount of applied compressive strain. Applying or releasing the strain can close or open an electrical circuit, thereby reversibly turning on or off an appliance (e.g., a LED) in the circuit.

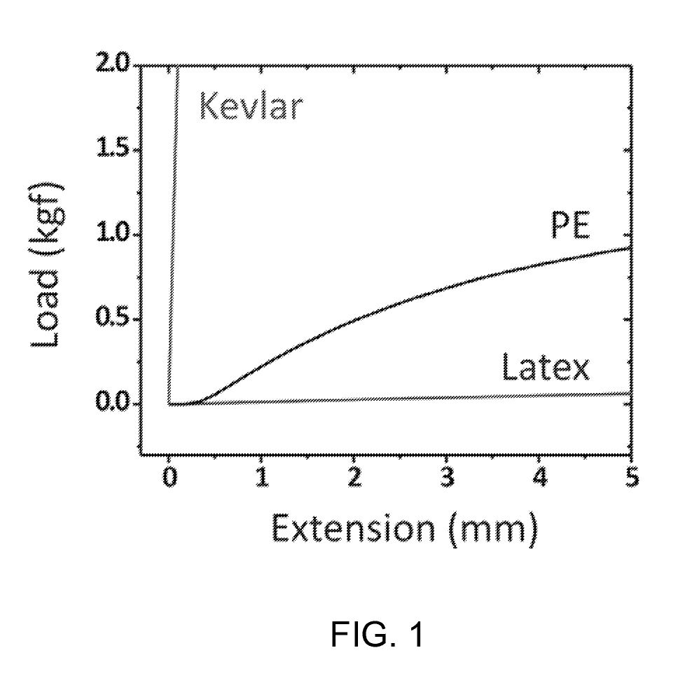

FIG. 1 illustrates mechanism properties of some exemplary materials, Latex rubber, Polyethylene (PE), and Kevlar aramid, that can be used to form multi-stage composites according to some embodiments of the disclosed subject matter. Test strips of each of the three materials demonstrate very different responses to applied loads. Multi-stage composite devices using these materials can be designed to elicit different responses of each of the materials when exposed to different mechanical stimuli, for example, a mechanical load. The mechanical properties (e.g., Young's modulus) of three exemplary materials (Latex, Polyethylene (PE), and Kevlar) are measured. In particular, strips (3 cm in width W and 15 cm in length L) of Latex, PE, and Kevlar are prepared. The mechanical properties of each strip are tested using a tensile tester (e.g., Instron 5566) by measuring stress while applying constantly increasing strain with a rate of 60 mm/min. The tested area of each sample is 3 cm W×9 cm L. In this example, Latex and PE are acquired from McMaster Can; Kevlar are acquired from Fibre Glast. As illustrated in FIG. 1, the Young's modulus (the slope of curve) of these three materials differ by at least one order of magnitude. For example, the Young's modulus is about 3.7 MPa for Latex, about 27 MPa for PE, and about 21 GPa for Kevlar. The significant difference in mechanical properties of these materials can allow them to be used to form CAMs including strain stiffening composites over a wide range of strain and stress. Other exemplary materials can include thermoplastic urethane, silicon-based elastomer, and Ecoflex, etc.

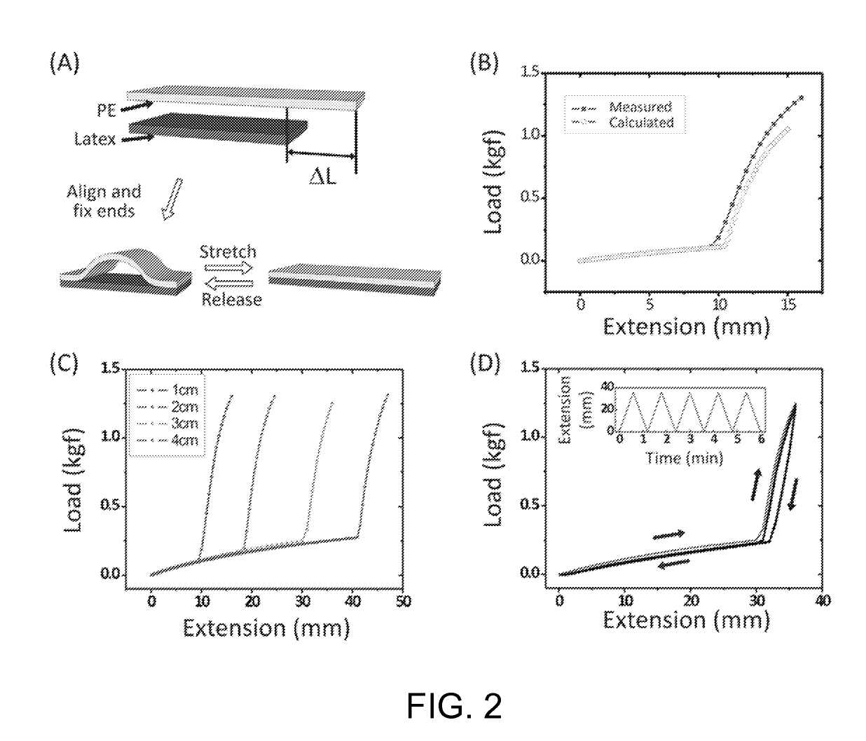

FIG. 2(A), (B), (C), and (D) illustrates an exemplary two-stage composite and its mechanical properties according to some embodiments of the disclosed subject matter. As illustrated in FIG. 2(A), two layers can be used to form a two-stage composite. In some embodiments, the two layers contain different materials (e.g., a shorter and more elastic Latex layer and a longer and stiffer PE layer). In this example, the two layers can optionally have the same width but different lengths. The length difference of the two layers can be defined as ΔL. The two layers can be aligned and affixed at both ends. In some embodiments, the two layers can be glued together at the both ends, e.g., using an appropriate adhesive, or by heat welding the materials together. In some other embodiments, the two layers can be sewed or clamped together at the both ends. The bond areas at the ends generally do not affect the properties of the composites. But the bond areas are usually large enough (e.g., 3 cm in W and 3 cm in L, approximately) to allow the secure coupling with the grippers of a tensile tester. The bond areas where the two layers are affixed and gripped by a tensile test can be excluded for the purpose of length measurement. Because the stiffer PE strip is flexible, the additional length can be accommodated by deflecting away from the shorter Latex rubber strip. Other configurations are contemplated, for example, where the longer stiffer strip ‘crimps’ or forms a wavy or undulating configuration.

As tensile strain is applied to the two-layer composite, the shorter Latex rubber strip elongates and the longer and wavy PE strip straightens. See, FIG. 2A. At the beginning when the tensile extension is less than ΔL, the mechanical properties of the shorter layer can control as the longer layer is not yet stretched; when the extension reaches ΔL, the mechanical properties of the two-layer composite can change dramatically as the mechanical properties of the longer layer start to dominate. The mechanical properties can be expressed in the equation below:

$$F ( x ) = \{ \begin{matrix}{F}_{Latex} , & 0 < x < Δ L \\ {F}_{Latex} + {F}_{PE} , & Δ L \leq x\end{matrix}$$

where F_{Latex} is the calculated load to stretch the Latex strip alone, F_{PE} is the calculated load to stretch the PE strip alone, F(x) is the calculated load to stretch the Latex-PE composite, and x is the extension. When F_{PE} is much larger than F_{Latex} (e.g., an order of magnitude larger), the F_{Latex} can become negligible comparing to F_{PE}. Note that the sum of the stress values of the two components of a composite can be different from the stress value of the composite. For example,

$$σ ( x ) = \frac{F ( x )}{{A}_{Latex} + {A}_{PE}} = \frac{{F}_{Latex} + {F}_{PE}}{{A}_{Latex} + {A}_{PE}} \neq \frac{{F}_{Latex}}{{A}_{Latex}} + \frac{{F}_{PE}}{{A}_{PE}} = {σ}_{Latex} + {σ}_{PE}$$

Here, σ_{Latex} is the stress of Latex, and σ_{PE} is the stress of PE in tension, and σ(x) is the stress of the composite. A_{Latex} is the cross sectional area (width×thickness) of Latex, and A_{PE} is the cross sectional area of PE.

FIG. 2(B) illustrates the two-step modulus of the Latex-PE composite, in which the different in length between the two strips (AL) is about 10 mm. ΔL can also be referred to as the threshold extension separating the two discrete moduli. In the example illustrated in FIG. 2(B), the extension threshold is about 10 mm. Thus, the multilayer composite responds substantially linearly with load up to an extension of about 10 m, during which the mechanical properties are governed primarily by the more flexible strip. As the extension threshold is reached, the second stiffer layer also begins to experience tensile strain and the extension is governed by both layers, although the stiffer layer predominates. When at least one layer is extended beyond its elastic region, it may undergo plastic deformation, resulting in non-linear mechanical response (e.g., illustrated in FIG. 2).

The threshold extensions can be adjusted so that the mechanical properties of the multi-stage composites are tunable. FIG. 2(C) illustrates that different ΔLs can lead to different threshold extensions. As ΔL gets longer and longer, the threshold extension also gets longer and longer accordingly (e.g., in good agreement).

FIG. 2(D) illustrates reversibility of mechanical properties of the multi-stage composite illustrated in FIG. 2(A). For example, a cyclical test is performed on the Latex-PE composite by applying a triangle-wave strain for five cycles to measure the reproducibility of the changes in mechanical strength. In this example, the extension threshold or ΔL is about 30 mm; the maximum extension is about 36 mm; and the strain rate is about 60 mm/min. As illustrated in FIG. 2(D), the composite shows reversible two-stepped modulus with little hysteresis.

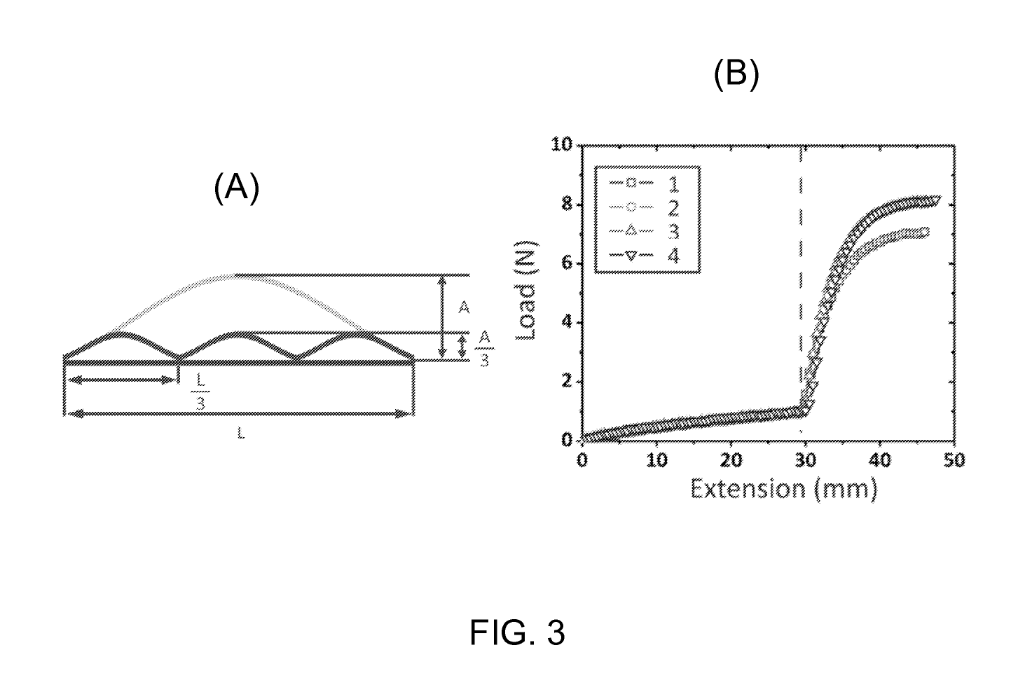

The arched structure of the longer layer in a multi-stage composite can potentially increase the footprint (e.g., size/volume) of the composite. The increased footprint can sometimes limit applications of multi-staged composites. In some embodiments, the size/volume of a stepped-modulus composite can be reduced by increasing the points of attachment between the two layers (e.g., points/lines/regions of attachment). Composites with smaller amplitudes of waves can be integrated more effectively into smaller volumes, while maintaining their mechanical properties and performances. Assuming a sinusoidal shape for the longer and stiffer component, the amplitude of the curve can decrease as the wavelength decreases while maintaining the arc length. As illustrated in FIG. 3(A), when the longer layer is affixed to the shorter layer at two more contact points/lines/regions, the amplitude of the curve (A) can be reduced to about A/3 while the wavelength (L) decreases to about L/3. Experiments have shown that multi-stage composites can largely maintain their stepped-modulus features when more contact points/lines/regions (or waves) are established between layers. For example, FIG. 3(B) illustrates that a two-stage composite maintains its two-step modulus with little change when the number of waves in the longer layer of the composite is one, two, three, or four.

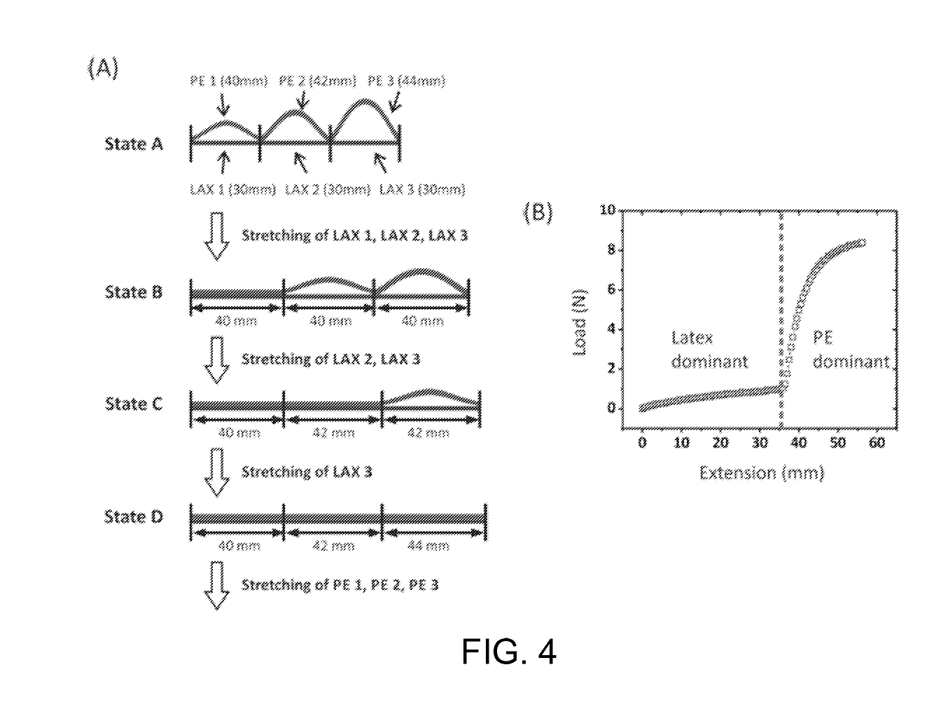

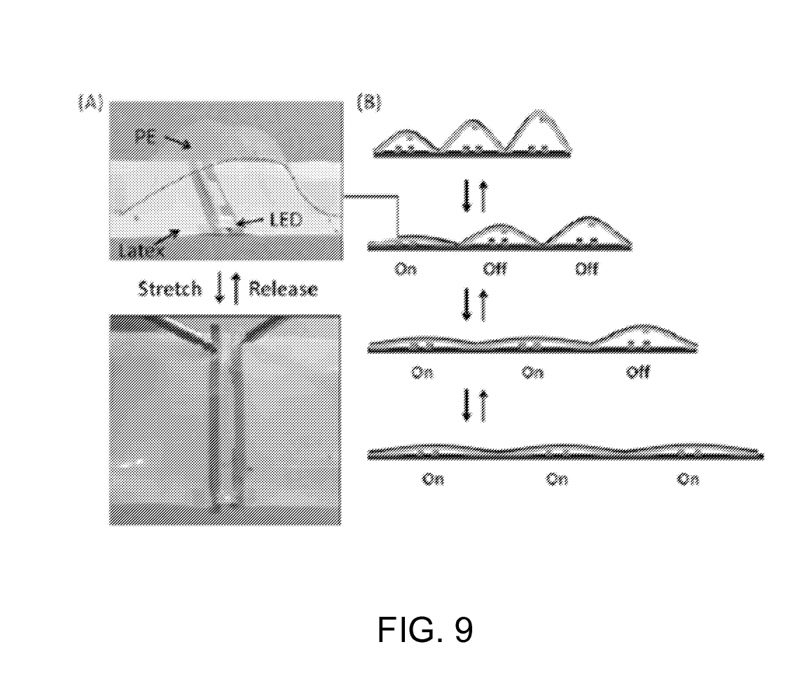

In one or more embodiments, the spacing between contact points is substantially the same. In other embodiments, the spacing between segments can differ. Experiments have also shown that multi-stage composites can maintain their stepped-modulus features regardless of the arc length of each segment (wave) defined between two contact points/lines/regions. FIG. 4(A) illustrates a two-stage Latex-PE composite with three segments. At state A, the composite is not stretched. Each individual segment of the PE layer has a different arc length. In particular, arc 1 is 40mm long; arc 2 is 42 mm long; and arc 3 is 44 mm long. The corresponding segments in the Latex layer have the same length 30 mm. At state B, the composite is stretched to the extent that arc 1 is flat and both arc 2 and arc 3 become less wavy. The corresponding segments in the Latex layer have all been extended to 40mm equally. At this moment, the more elastic Latex layer controls the mechanical properties of the composite. At state C, the composite is further stretched to the extent that both arc 1 and arc 2 are flat and arc 3 becomes even less wavy. The segment in the Latex layer corresponding to arc 1 remains at 40 mm long. The segments in the Latex layer corresponding to arc 2 and arc 3 have both been extended to 42 mm long equally. At this moment, the more elastic Latex layer still controls the mechanical properties of the composite. At state D, the composite is even further stretched to the extent that all three arcs are flat. The segment in the Latex layer corresponding to arc 1 remains at 40 mm long. The segment in the Latex layer corresponding to arc 2 remains at 42 mm long. The segment in the Latex layer corresponding to arc 3 has been extended to 44 mm long. Up until this moment, the more elastic Latex layer has been controlling the mechanical properties of the composite since the stiffer PE layer has not been elongated. When the composite is extended beyond state D, the stiffer PE layer starts to dominate. FIG. 4(B) demonstrates the mechanical properties of the Latex-PE composite illustrated in FIG. 4(A). As FIG. 4(B) shows, the extension threshold is about 36 mm, which is roughly equal to the sum of the length differences of the three segments between the two layers (e.g., the Latex layer and the PE layer). The two-stage composite can maintain its two-step modulus even if there are multiple waves of the longer and stiffer layer with each individual wave differing in arc length. On one hand, equally sized segments can be more desirable to make composites smaller when the smallest size of the wave is limited by the fabrication methods, equipment resolution, cost, and etc. On the other hand, different sized segments can be desirable to improve versatility (e.g., as illustrated in FIG. 9 later).

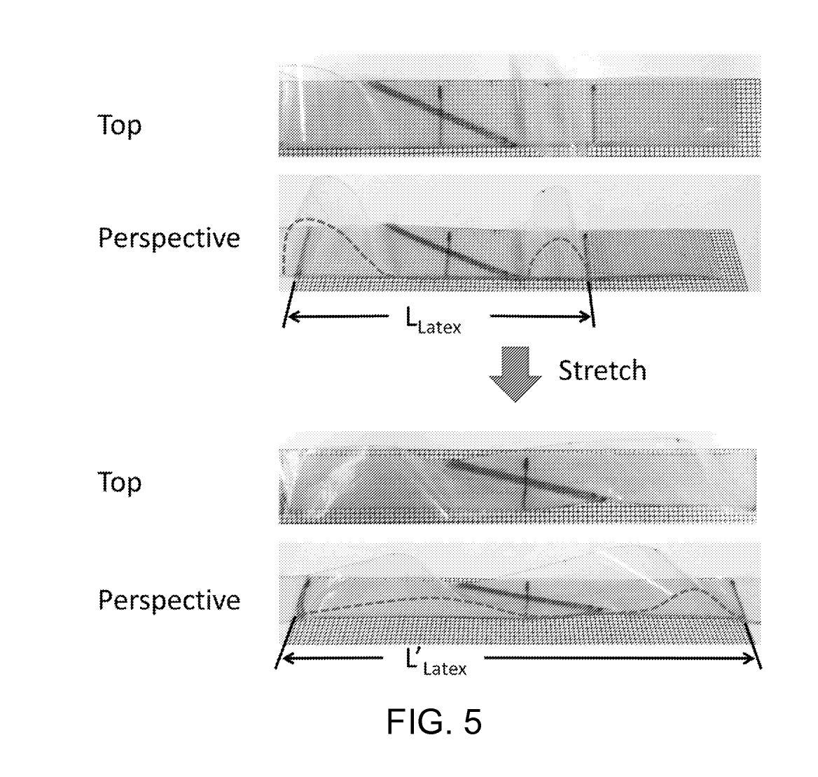

In the embodiments above, layers can be attached along attachment lines which are generally perpendicular to the extension direction of the composite. In some other embodiments, the two layers can be attached along attachment lines which are not perpendicular to the longitude direction of the composite. For example, as illustrated by FIG. 5, the attachment lines can be diagonal across the surfaces of the layers. As a result, the lengths of the arcs of the longer layer can vary along the width of the composite. In this situation, the number of steps in tensional modulus can still depend on the number of layers or constituent materials but the shape of the composite can distort as the longer side of the more elastic layer can undergo greater extension than the shorter side at the same amount of load. In some embodiments, the shape changes can be used in transferring the tensile strain to neighboring composites in other planes and orientations.

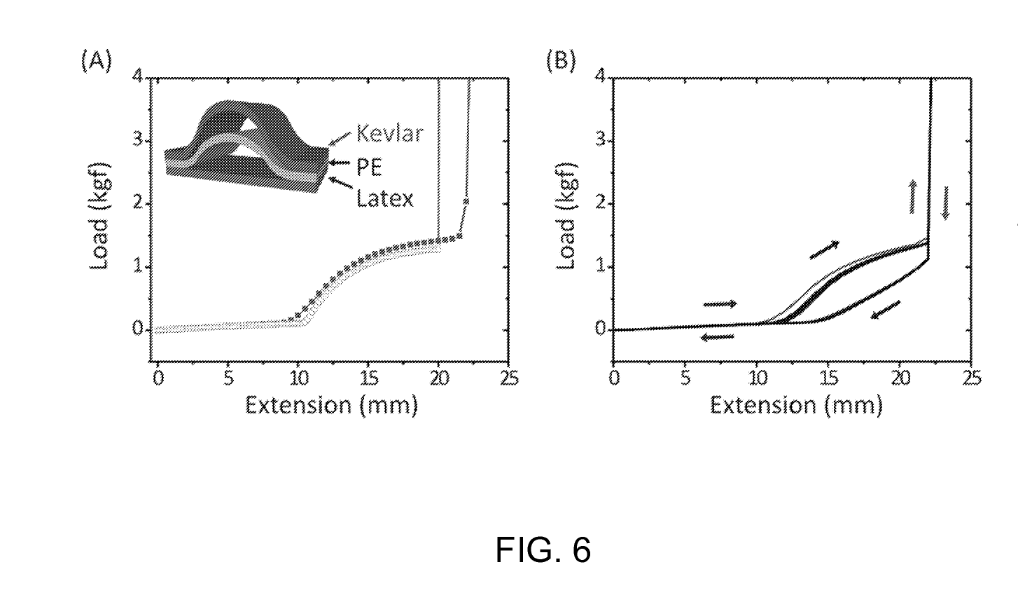

The multi-stage composites in the disclosed subject matter are not limited to two stages or two layers. FIG. 6(A) and (B) illustrates an exemplary three-stage composite and its mechanical properties according to some embodiments of the disclosed subject matter. Any number of layers can be included in the composite, such a four, five, six, up to ten, or more layers. As illustrated in FIG. 6(A), three layers can be used to form a three-stage composite. In some embodiments, the three layers can include different materials. In this example, the three layers can have increasing stiffness and lengths—a short and elastic Latex layer, a longer and stiffer PE layer, and an even longer and stiffer Kevlar layer. The three layers can have the same width but different lengths. The length difference of the Latex and PE layers can be defined as ΔL_{PE-Latex}; the length difference of the PE and Kevlar layers can be defined as ΔL_{Kevlar-PE}; and thus the length difference of the Latex and Kevlar layers can be defined as ΔL_{Total}=ΔL_{PE-Latex}+ΔL_{Kevlar-PE}. The three layers can be aligned and affixed at both ends. In some embodiments, the three layers can be glued together at the both ends. The contact areas where the three layers are affixed and gripped by a tensile test can be excluded for the purpose of length measurement.

Referring to FIG. 6(A), as tension strain is applied to the three-layer composite, the Latex strip elongates first while the longer and wavy PE and Kevlar strips straighten. At the beginning when the tensile extension is less than ΔL_{PE-Latex}, the mechanical properties of the shortest Latex layer controls as the longer layers are not yet stretched; when the extension reaches ΔL_{PE-Latex}, the mechanical properties of the three-layer composite can change dramatically as the middle PE layer starts to dominate; and when the extension further reaches ΔL_{Total}, the mechanical properties of the three-layer composite can change dramatically again as the longest Kevlar layer starts to dominate. The mechanical properties of the three-stage composite can be expressed in the equation below:

$$F ( x ) = \{ \begin{matrix}{F}_{Latex} , & 0 < x < Δ {L}_{PE - Latex} \\ {F}_{Latex} + {F}_{PE} , & Δ {L}_{PE - Latex} \leq x < Δ {L}_{Total} \\ {F}_{Latex} + {F}_{PE} + {F}_{Kevlar} , & Δ {L}_{Total} \leq x\end{matrix}$$

where F_{Latex} is the calculated load to stretch the Latex strip alone, F_{PE} is the calculated load to stretch the PE strip alone, F _{Kevlar} is the calculated load to stretch the Kevlar strip alone, and F(x) is the calculated load to stretch the Latex-PE-Kevlar composite, and x is the extension. As in a two-component composite discussed earlier, the sum of the stress values of the three components of a composite can be different from the stress value of the composite.

Still referring to FIG. 6(A), the three-layer Latex-PE-Kevlar composite can have a three-step modulus. ΔL_{PE-Latex} and ΔL_{Total} can be the two extension thresholds separating the three discrete modulus. In the example illustrated in FIG. 6(A), the first extension threshold is about 10 mm, and the second extension threshold is about 20 mm. Extension thresholds can be adjusted so that the mechanical properties of multi-stage composites are tunable.

FIG. 6(B) illustrates reversibility of mechanical properties of the multi-stage composite illustrated in FIG. 6(A). For example, a cyclical test is performed on the Latex-PE-Kevlar composite to measure the reproducibility of the changes in mechanical strength. In this example, the maximum extension is about 23 mm, and the strain rate is about 60 mm/min. As illustrated in FIG. 6(B), the composite shows reversible three-stepped modulus with little hysteresis.

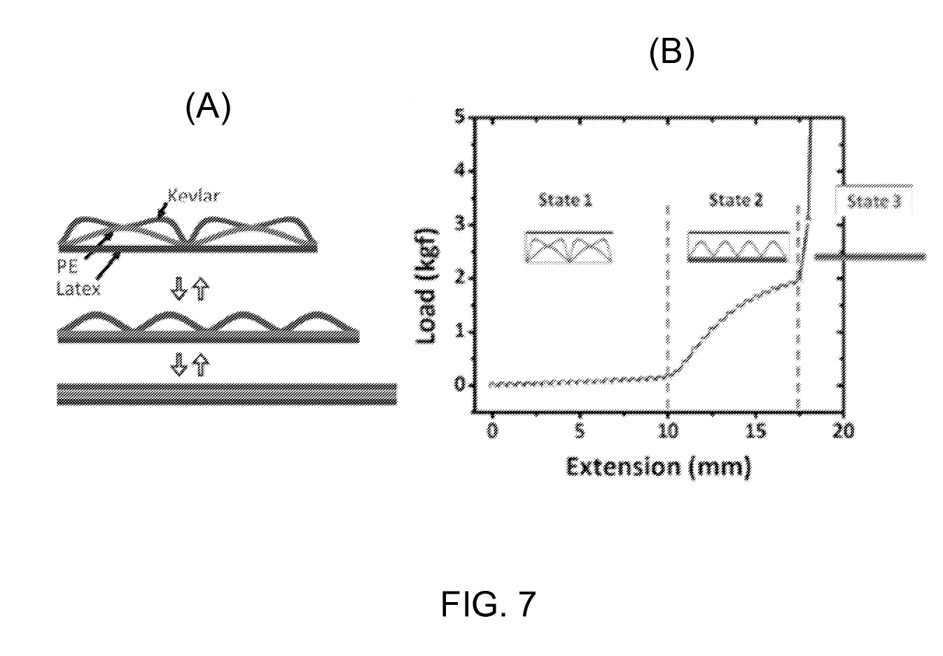

Similar to a two-stage composite as illustrated in FIG. 3, three (or more)-stage composites can also reduce their footprint (e.g., sizes/volumes, height clearance, etc.) by adopting different geometries (e.g., points/lines/regions of attachment.) In some embodiments, a three-stage composite can adopt a hierarchical structure containing multiple generations of waves. FIG. 7(A) illustrates a Latex-PE-Kevlar three-layer composite. The middle PE layer can be affixed onto the bottom Latex layer (most elastic) at at least two attachment points/lines/regions. The top Kevlar layer (stiffest) can be affixed to the middle PE layer and the bottom Latex layer at the same attachment points/lines/regions. In addition, the top Kevlar layer can also be affixed to the middle PE layer at additional attachment points/lines/regions. This mechanism can form multiple generations of waves in a hierarchical structure. For example, the additional attachment points/lines/regions can form waves in the top Kevlar layer with a smaller span than the waves of the middle PE layer.

FIG. 7(B) illustrates the mechanical properties of the Latex-PE-Kevlar composite illustrated in FIG. 7(A). As FIG. 7(B) shows, the three-layer Latex-PE-Kevlar composite can maintain its three-step modulus when it includes multiple segments in a hierarchical structure. In this example, the first extension threshold is about 10 mm and the second extension threshold is about 17 mm.

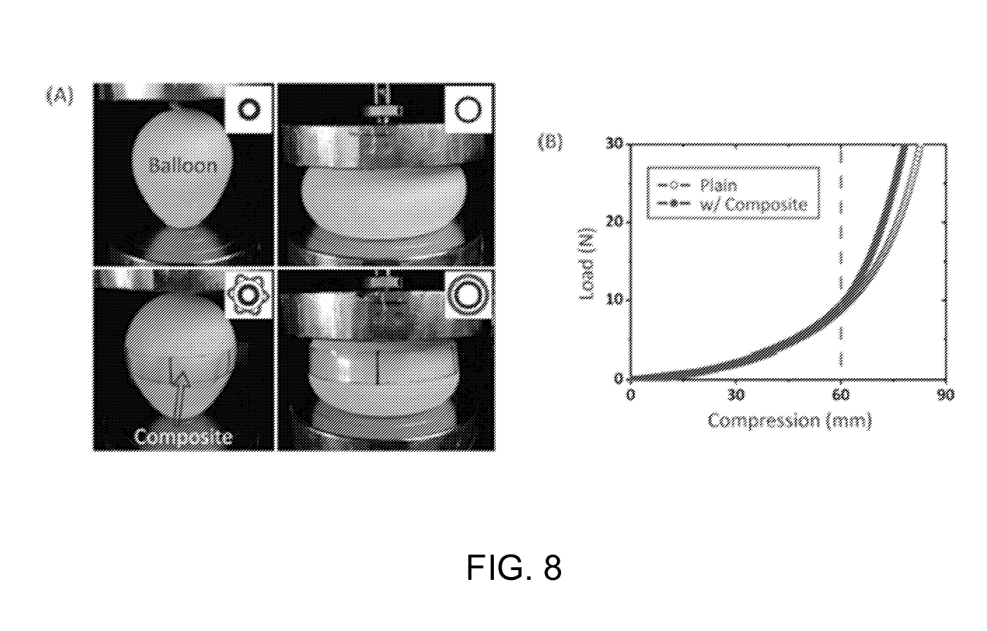

The stepped mechanical strength of multi-stage composites is not limited to be only responding to tensional strains but can be responding to other types of mechanical stimuli. In the example illustrated in FIG. 8, a compressive force applied in one direction can be translated into a tensile force in a different direction. With force/direction translation, a multi-stage composite can change its mechanical strength in response to a compressive strain. Referring to FIG. 8(A), the top left diagram shows an inflated rubber balloon. The top right diagram shows the inflated rubber balloon is compressed along its vertical direction. The bottom left diagram shows the inflated rubber balloon is wrapped around by a PE-Latex two-stage composite strip. The bottom right diagram shows the inflated rubber balloon with the composite strip is compressed along its vertical direction. As the balloon is vertically compressed, it expands in its horizontal dimension and therefore applies tensile strain to the composite strip. The mechanical load to the PE-Latex composite strip can then be measured while the balloon is being compressed. The insets in the four diagrams illustrate the cross sectional shapes and approximate sizes of the rubber balloon and the composite strip wrapped around it. The solid annular rings in the insets of the top two diagrams represent the plain balloon. The annular rings in the insets of the bottom two diagrams represent the balloon (solid), the Latex layer (empty) and the PE layer (solid), respectively from the center to the perimeter. As illustrated in FIG. 8(B), the measured load of the balloon with the composite strip shows a higher load than a plain balloon in greater than 60 mm of compression strain. The relatively small increase in the load when compared to the difference in mechanical strength of PE and rubber can be attributed to the stress distributed to the bare top and bottom parts of the balloon. In some other embodiments, other type of mechanical forces (e.g., shear or torsional stress) can be transduced to tensile stress.

The multi-stage composites in the disclosed subject matter can have many applications across a wide range of fields. In one aspect, multi-stage composites can allow engineered or configurable mechanical properties. Multi-stage composites can be manufactured with a variety of materials, such as plastics, fabrics, paper, and foils, etc. Combinations of these materials with different sizes and properties can produce a composite with dynamic mechanical properties. The dynamic properties of multi-stage composites can be engineered to suit the requirements for specific applications (e.g. sensors, actuators, etc.). In another aspect, multi-stage composites can serve as bio-inspired materials. Examples of natural materials with an increasing modulus with applied strain can include skin, arteries, ligaments, and tendons, etc. The strain stiffening properties can manifest a J-shaped stress-strain curve. These bio-inspired composites can mimic the mechanical properties of natural materials. In yet another aspect, multi-stage composites can be used in non-linear systems. The multi-stage composites are analogous to shear-thickening fluids although the mechanical strength of the composites increases with the absolute amount of strain rather than the strain rate. Dilatants, for example, have been used as an energy-absorbent medium in protective clothing. Likewise, the multi-stage composites can allow the cloth wearer to have a normal range of motion and yet resist large strain that may cause injury. They can be used to assist rehabilitation and/or prevent joint injury for patients and athletes. In yet another aspect, multi-stage composites can work as mechanical diodes. The multi-stage composites can have at least two distinct regions of mechanical strength. The characteristic is analogous to current rectification in electrical diodes. For example, small changes in strain, near the threshold strain, can lead to large changes in modulus. This asymmetric characteristic could be useful in constructing complex materials that mimic electronic devices, like transistors or switches.

For example, a multi-stage composite's feature of spacing apart two layers in a unstimulated state and contacting the two layers in a stimulated state can be used for a variety of applications, such as closing a switch or completing a circuit. In some embodiments, electrical switches sensing and responding to multiple stages of extension can be manufactured using multi-stage composites. In the example illustrated in FIG. 9(A), a single electric switch can be manufactured using a PE-Latex composite. Referring to FIG. 9(A), an open circuit (e.g., a disconnected thin strip of copper fabric) can be deposited on the inner surface (facing the PE layer) of the Latex layer of the PE-Latex composite. A conductor strip (e.g., another thin strip of copper fabric) can be deposited on the inner surface (facing the Latex layer) of the PE layer of the PE-Latex composite. The open circuit and the conductor strip can be so positioned that the conductor strip on the PE layer makes contact with and closes the open circuit on the Latex layer when the strain exceeds a threshold extension. The circuit can be connected to a power supply, so that a connected appliance (e.g., a LED) can be turned on when the strain is applied to close the circuit and turned off when the strain was released to open the circuit.

In another example illustrated in FIG. 9(B), multi-stage composites (e.g., a Latex-PE composite) can be used to manufacture multi-switch electrical circuits. Referring to FIG. 9(B), the longer and stiffer PE fabric has increasing arc length from left to right. The left switch is turned on first when the composite is stretched to a certain extent. The middle switch and the right switch will be closed in turn when the composite is further stretched. As in the example illustrated in FIG. 4, once the left switch is closed, more extension does not elongate the first circuit until the middle and right switches are both closed, since the mechanical strength of the first switch is dominated by the stiffer PE layer (a.k.a., “locked by the stiff component). This characteristic can allow for the closed circuit(s) to remain independent from successive extensions and maintain stable electrical contacts. This type of switches can be used to monitor body movements. The fabric-based switches can be easy to fabricate, reconstruct and repair when damaged, and can be readily introduced to commercial textiles with low cost and new possibilities.

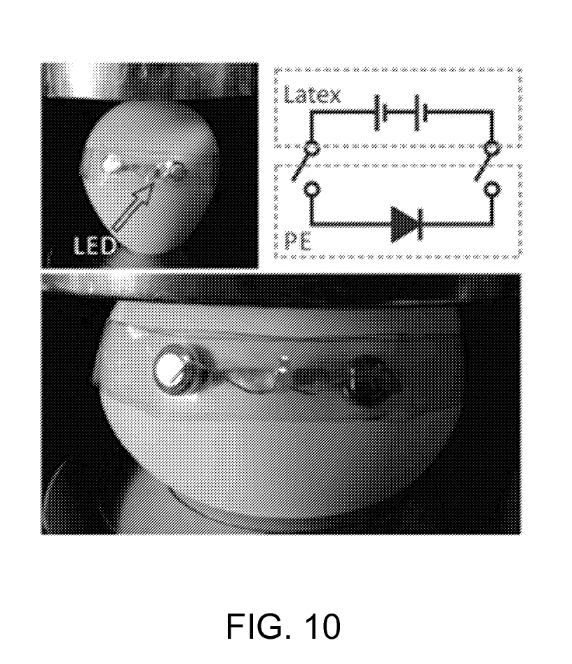

FIG. 10 illustrates another exemplary application of an exemplary multi-stage composite. The electrical switch in FIG. 10 can sense and respond to compression strain. The electrical switch consisted of batteries and thin strips of aluminum foil attached on the Latex strip of the PE-Latex composite, and an LED attached on the PE strip of the PE-Latex composite. The circuit diagram in its open state is shown at the top right corner of FIG. 10. The composite with the switch is banded around a rubber balloon to monitor a compressive strain applied to the rubber balloon. As in the example illustrated in FIG. 8, the compressive strain on the balloon can be transduced to a tensile strain on the composite strip. Before strain is applied, the LED is on an “off” state. As the balloon is compressed, the gap between the Latex and PE layers can gradually decrease and can finally close the electrical circuit to turn on the LED as the extension threshold is reached. The electrical switch with the composite demonstrates the possibility of digital sensing and responding to the amount of physical deformation (e.g., body movements).

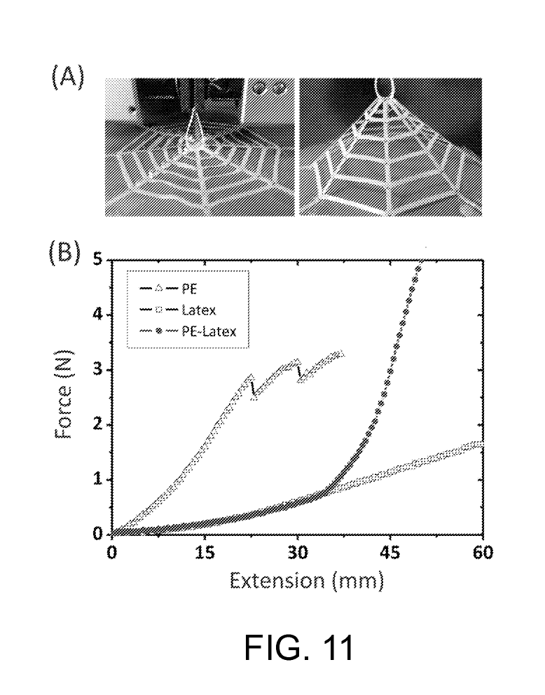

The geometries of stepped modulus composites are not limited to one-dimensional structures and can be designed to respond to mechanical stimuli in different directions. FIG. 11(A) demonstrates an example of two-dimensional stepped modulus composite fabricated using a PE-latex composite with an octagonal web-like configuration. FIG. 11(A) shows a PE-latex layered composite with an octagonal, web-like configuration at rest on the left and in tension on the right. The composite consists of a web of latex and strips of PE attached along the eight radial lines of the web. At rest, the long diagonal of the latex octagonal web is 91 mm and the length of PE layer attached along the four diagonal lines is 113 mm. The width of each segment is 2 mm. The ends of the diagonal segments of the composite are fixed to the substrate and using a metal wire hooked at the center of the composite tensile test is performed. When tension is applied by lifting the center of the composite, while the ends of the radial lines are fixed to the substrate, the composite shows an increase in modulus at ˜35 mm of elevation. FIG. 11(B) shows the force-extension profiles of a single PE (Δ), a single latex (□) and the PE-latex composite () of the same web configuration. As shown in FIG. 11(B), the single PE layer begins to break at a strain of ˜20 mm of extension. When compared to a web of latex alone, the PE-latex composite withstands the same stress of approximately 5 N at 50 mm of elevation while the web of latex alone requires a 170 mm of elevation, thereby demonstrating the ability to withstand the same stress at much lower strain values. Also, FIG. 11(B) shows that the web of single PE layer begins to break at lower strain values of approximately 20 mm of elevation as compared to the composite which starts to break at 55 mm of elevation. The PE-latex composite prevented physical failure at low strain and severe deformation at high stress. This behavior is analogous to the superior fault tolerance of the web of strain-stiffening spider silks. According to the Pythagorean theorem, the measured value of threshold elevation is consistent with calculated value of 33.5 mm using the equation below, where L_{PE} is 113 mm and L_{Latex} is 91 mm.

$$h = \sqrt{{( \frac{{L}_{PE}}{2} )}^{2} - {( \frac{{L}_{Latex}}{2} )}^{2}}$$

Those skilled in the art would readily appreciate that all parameters and configurations described herein are meant to be exemplary and that actual parameters and configurations will depend upon the specific application for which the systems and methods of the present invention are used. Those skilled in the art will recognize, or be able to ascertain using no more than routine experimentation, many equivalents to the specific embodiments of the invention described herein. It is, therefore, to be understood that the foregoing embodiments are presented by way of example only and that the invention may be practiced otherwise than as specifically described. The present invention is directed to each individual feature, system, or method described herein. In addition, any combination of two or more such features, systems or methods, if such features, systems or methods are not mutually inconsistent, is included within the scope of the present invention.

1. A composite, comprising:
a first layer of a first material having a first length requiring a first load to produce each unit of incremental extension;
a second layer of a second material having a second length requiring a second load to produce each unit of incremental extension,
wherein the second length is greater than the first length,
wherein the second length of the second layer is affixed to the first length of the first layer at both ends of the first and second lengths so that the second layer is spaced apart from the first layer; and
wherein, extension of the composite from the first length to the second length results in at least one change in the load required to produce each unit of incremental extension.

2. The composite of claim 1, wherein the second load required to produce each unit of incremental extension of the second material is same as the first load required to produce each unit of incremental extension of the first material.

3. The composite of claim 1, wherein the second load required to produce each unit of incremental extension of the second material is different from the first load required to produce each unit of incremental extension of the first material.

4. The composite of claim 1, wherein the second load required to produce each unit of incremental extension of the second material is greater than the first load required to produce each unit of incremental extension of the first material.

5. The composite of claim 4, wherein the second load required to produce each unit of incremental extension of the second material is at least an order of magnitude greater than the first load required to produce each unit of incremental extension of the first material.

6. The composite of claim 1, wherein the second layer is affixed to the first layer at at least one additional contact region so that the second layer includes at least two spaced apart sections.

7. The composite of claim 6, wherein the at least two spaced apart sections have the same arc length.

8. The composite of claim 6, wherein the at least two spaced apart sections have different arc lengths.

9. The composite of claim 1, further comprising:
a third layer of a third material having a third length requiring a third load to produce each unit of incremental extension,
wherein third length is greater than the second length,
wherein the third length of the third layer is affixed to the first and second lengths at both ends of the first, second, and third lengths so that the third layer is spaced apart from the first and second layers; and
wherein, extension of the composite from the first length to the third length results in at least two changes in the load required to produce each unit of incremental extension.

10. The composite of claim 9, wherein the third load required to produce each unit of incremental extension of the third material is same as the second load required to produce each unit incremental extension of the second material.

11. The composite of claim 9, wherein the third load required to produce each unit incremental of extension of the third material is different from the second load required to produce each unit of incremental extension of the second material.

12. The composite of claim 9, wherein the third load required to produce each unit incremental extension of the third material is greater than the second load required to produce each unit of incremental extension of the second material.

13. The composite of claim 9, wherein the third load required to produce each unit of incremental extension of the third material is at least an order of magnitude greater than the second load required to produce each unit of incremental extension of the second material.

14. The composite of claim 9, wherein the third layer is affixed to the second layer at at least one additional contact region so that the number of spaced apart sections in the third layer is greater than the number of spaced apart sections in the second layer.

15. A method of preparing a composite, comprising:
providing a first layer of a first material having a first length requiring a first load to produce each unit of incremental extension;
providing a second layer of a second material having a second length, requiring a second load to produce each unit of incremental extension wherein the second length is greater than the first length; and
affixing the second length of the second layer to the first length of the first layer at both ends of the first and second lengths so that the second layer is spaced apart from the first layer; and
wherein, extension of the composite from the first length to the second length results in at least one change in the load required to produce each unit of incremental extension of the composite.

16. The method of claim 15, further comprising:
providing a third layer of a third material having a third length requiring a third load to produce each unit of incremental extension, wherein third length is greater than the second length; and
affixing the third length of the third layer to the first and second lengths at both ends of the first, second, and third lengths so that the third layer is spaced apart from the first and second layers; and
wherein, extension of the composite from the first length to the second length results in at least one change in the load required to produce each unit of incremental extension of the composite.

17. A device, comprising:
a first layer of a first material having a first length requiring a first load to produce each unit of incremental extension; and
a second layer of a second material having a second length requiring a second load to produce each unit of incremental extension, wherein the second length is greater than the first length,
wherein the second length of the second layer is affixed to the first length of the first layer at both ends of the first and second lengths,
wherein the second layer is spaced apart from the first layer in an unengaged state,
wherein the second layer is no longer spaced apart from the first layer in an engaged state.

18. The device of claim 17, wherein:
the first layer contains a first active section;
the second layer contains a second active section;
the first and second active sections are not in contact in the unengaged state; and
the first and second active sections are in contact in the engaged state.

19. The device of claim 18, wherein:
the first active section contains a first conductive strip; and
the second active section contains a second conductive strip.

20. A method of using the composite of claim 1, comprising:
applying a first strain to the composite to stretch the first layer from its original first length to the second length of the second layer, wherein the first strain requires the application of a first load to produce each unit of incremental extension ; and
applying a second strain to the to the composite to stretch the first and second layer from the second length to a length greater than the second length, wherein the second strain requires the application of a second load to produce each unit of incremental extension.

21. The device of claim 17, wherein:
the first load required to produce each unit of incremental extension of the first layer and the second load required to produce each unit of incremental extension of the second layer have the same value.
